(19) United States
(12) Patent Application Publication
(10) Pub. No.: US 2024/0326645 A1
(43) Pub. Date: Oct. 3, 2024

(54) SYSTEMS AND TECHNIQUES FOR DISPATCHING AUTONOMOUS VEHICLES TO AUTONOMOUS VEHICLE MAINTENANCE FACILITIES

(71) Applicant: GM Cruise Holdings LLC, San Francisco, CA (US)

(72) Inventors: Alexander Case, San Francisco, CA (US); Michael Rusignola, Burlingame, CA (US); Hakan Tunc, Seattle, WA (US); Jun Zhou, San Francisco, CA (US); Yufeng Liu, Moraga, CA (US); Thomas Kielbus, San Francisco, CA (US); Armin Mahmoudi, Los Gatos, CA (US)

(21) Appl. No.: 18/194,433

(22) Filed: Mar. 31, 2023

(51) Int. Cl. B60L 58/12; G01C 21/34; G06Q 10/20

(52) U.S. Cl. CPC B60L 58/12; G01C 21/3469; G06Q 10/20; B60L 2240/62

(57) ABSTRACT

Systems and techniques are provided for dispatching autonomous vehicles to maintenance facilities. An example process can include receiving, from a plurality of autonomous vehicles (AVs), AV location data and AV battery data; determining, based on the AV location data and AV dispatch information, a first predicted energy usage for routing each of the plurality of AVs to one or more waypoints; determining, based on AV maintenance facility location data, a second predicted energy usage for routing each of the plurality of AVs to one or more AV maintenance facilities; determining, based on the first predicted energy usage, the second predicted energy usage, and the AV battery data, a projected battery charge state for each of the plurality of AVs; and sending routing instructions to one or more of the plurality of AVs that are based on the projected battery charge state.

### BACKGROUND

### 1. Technical Field

The present disclosure generally relates to autonomous vehicles (AVs) and an AV fleet management system. For example, aspects of the present disclosure relate to systems and techniques for dispatching AVs to AV maintenance facilities.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate autonomous vehicle (AV) dispatch and operations, according to some aspects of the disclosed technology;

FIG. 2 illustrates an example of an AV fleet management system, according to some aspects of the present disclosure;

FIG. 3 illustrates another example of an AV fleet management system, according to some aspects of the present disclosure;

FIG. 4 illustrates an example scene for dispatching AVs to maintenance facilities, according to some aspects of the present disclosure;

FIG. 5 illustrates an example of a deep learning neural network that can be used to implement aspects of an AV fleet management system or an AV, according to some aspects of the present disclosure;

FIG. 6 illustrates an example process for routing AVs to AV maintenance facilities, according to some aspects of the present disclosure; and

FIG. 7 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspects of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

Some ridesharing and/or ride-hailing services utilize autonomous vehicles (AVs) to transport passengers from one location to another. In contrast to conventional transportation services where a human driver picks up passengers and drives them to their destination, AVs can drive themselves, eliminating the need for a human driver. For example, upon receiving a ride request from a user/user device (e.g., a ride requestor), a fleet management system may match and dispatch an AV in one or more fleets of AVs to the user. In addition to matching and dispatching, the fleet management system is responsible for the operations and maintenance of the AVs in the fleet. In order to optimize the efficiency and safety of the fleet, the fleet management system needs to efficiently dispatch AVs to their respective tasks and routes, and manage timely and proper maintenance of the AV.

In some cases, the fleet management system matches an AV, in response to a ride request, primarily based on the distance that is required for the AV to travel. For example, the fleet management system may select an AV that is closest to a pick-up location and has enough power to complete the ride. However, even for the same distance, the total power consumption (e.g., electric energy consumption) for the completion of the ride may vary depending on various environmental and/or vehicle-specific factors. For example, a different road condition (e.g., uphill or downhill, paved or unpaved) can result in varying power consumption of an AV. In another example, the age of an AV or a battery may affect the energy efficiency and result in a different power consumption vehicle by vehicle.

In some instances, the fleet management system dispatches an AV to an AV maintenance facility when the battery reaches a threshold level. For example, the fleet management system may direct an AV to an AV maintenance facility for charging when the battery is at 20% of the charge capacity.

Systems, apparatuses, processes (also referred to as methods), and computer-readable media (collectively referred to as “systems and techniques”) are described herein for routing AVs to an AV maintenance facility based on nuanced charge predictions, dispatch information, and/or maintenance requirements. For example, the systems and techniques described herein can be used to predict the energy usage for routing an AV to one or more AV maintenance facilities. In some cases, the predicted energy usage can be based on factors such as distance, predicted travel time (e.g., based on traffic conditions, road conditions, weather, etc.), route characteristics (e.g., speed limit, traffic lights, stop signs, road grade, etc.) and/or vehicle-specific factors such as vehicle age, battery charge state, battery charge cycles, etc. In some cases, the predicted energy usage can be used to determine a projected battery charge state for the AV upon arriving at each of the AV maintenance facilities. In some examples, the AV may be routed to a selected AV maintenance facility based on the projected battery charge state.

In some aspects, the systems and techniques described herein can also be used to predict the energy usage for routing the AV to one or more waypoints associated with dispatch information (e.g., ride-hailing request, delivery request, etc.). In some examples, the energy usage for routing the AV to one or more waypoints may also be used to determine the projected battery charge state. In some aspects, an AV may be instructed to navigate to one or more waypoints before navigating to a selected AV maintenance facility based on the projected battery charge state.

In some cases, the systems and techniques described herein can also be used to route AVs for AV maintenance facilities based on actual and/or projected demand for AV services. For instance, the fleet management server may instruct AVs to navigate to AV maintenance facilities to complete charging and/or maintenance activities prior to increased demand for AV services. In one illustrative example, an AV may be instructed to “top-off” its battery charge when the current battery charge state is relatively high (e.g., greater than 50%) so that the AV is available for service at a later time when demand is increased.

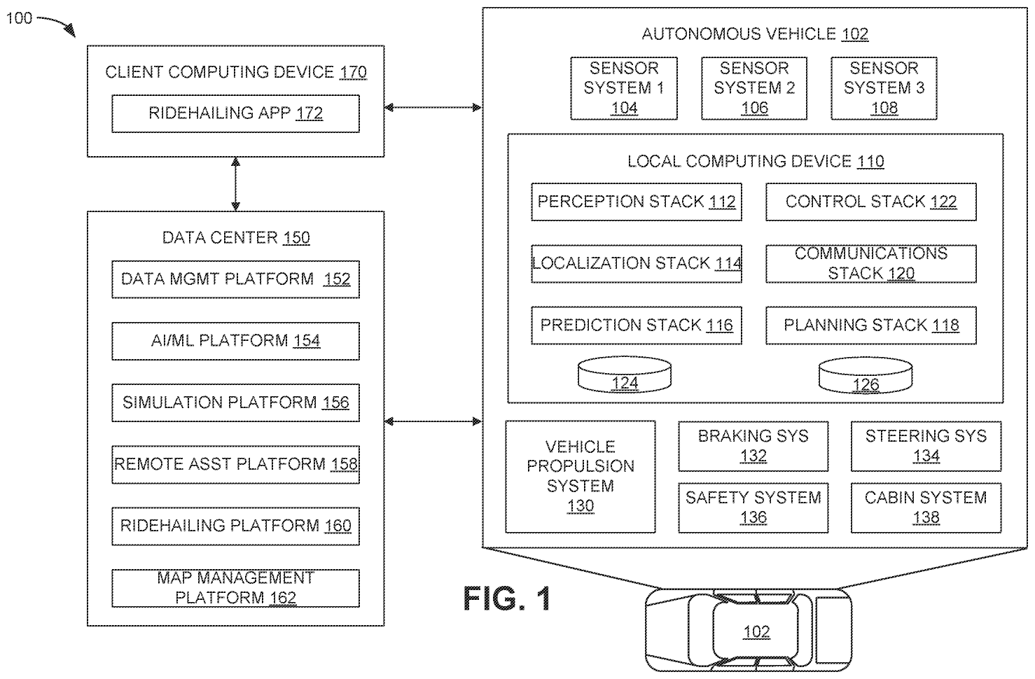

FIG. 1 is a diagram illustrating an example autonomous vehicle (AV) environment 100, according to some examples of the present disclosure. One of ordinary skill in the art will understand that, for AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the perception stack 112 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

Prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

Planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

Control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

Communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls layer can include geospatial information of traffic signal lights, traffic signs, and other road objects and related attributes.

AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

Data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ride-hailing service (e.g., a ridesharing service), a delivery service, a remote/roadside assistance service, street services (e.g., street mapping, street patrol, street cleaning, street metering, parking reservation, etc.), and the like.

Data center 150 can send and receive various signals to and from the AV 102 and the client computing device 170. These signals can include sensor data captured by the sensor systems 104-108, roadside assistance requests, software updates, ride-hailing/ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ride-hailing platform 160, and a map management platform 162, among other systems.

Data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ride-hailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

Simulation platform 156 can enable testing and validation of the algorithms, machine learning models, neural networks, and other development efforts for the AV 102, the remote assistance platform 158, the ride-hailing platform 160, the map management platform 162, and other platforms and systems. Simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

Remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

Ride-hailing platform 160 can interact with a customer of a ride-hailing service via a ride-hailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 172. The client computing device 170 can be a customer's mobile computing device or a computing device integrated with the AV 102 (e.g., the local computing device 110). The ride-hailing platform 160 can receive requests to pick up or drop off from the ride-hailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ride-hailing platform 160 may incorporate the map viewing services into the ride-hailing application 172 to enable passengers to view the AV 102 in transit en route to a pick-up or drop-off location, and so on.

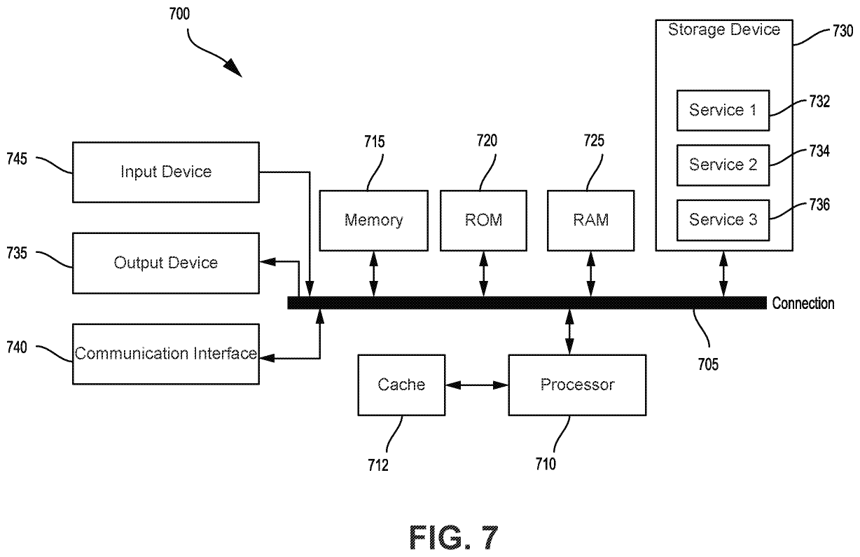

While the autonomous vehicle 102, the local computing device 110, and the autonomous vehicle environment 100 are shown to include certain systems and components, one of ordinary skill will appreciate that the autonomous vehicle 102, the local computing device 110, and/or the autonomous vehicle environment 100 can include more or fewer systems and/or components than those shown in FIG. 1. For example, the autonomous vehicle 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 7.

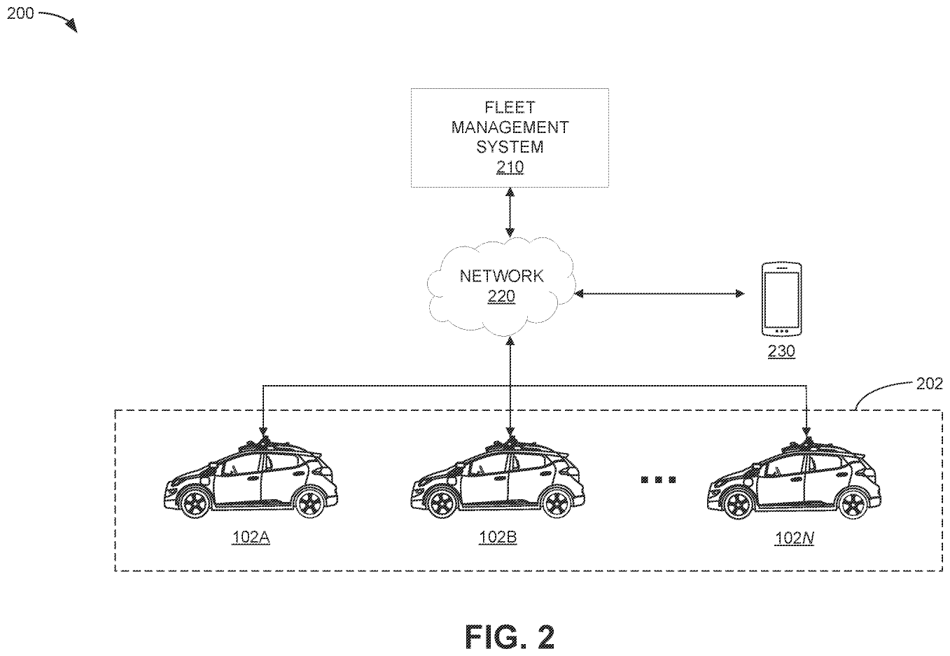

FIG. 2 illustrates an example system environment 200 for an AV fleet management system 210. As shown, system environment 200 includes a fleet management system 210 that may be communicatively connected, over network 220, to a user device 230 (e.g., similar to client computing device 170 as illustrated in FIG. 1) and an AV fleet 202 that can include AV 102A, AV 102B, . . . , AV 102N. Although FIG. 2 illustrates a single fleet management system 210, a single AV fleet 202, a single network 220, and a single user device 230, the present disclosure can be implemented with any number of fleet management systems, AV fleets, and/or user devices. For example, the system environment 200 may include one or more fleet management systems 210, AV fleets 202, networks 220, and/or user devices 230.

In some examples, fleet management system 210 may send and receive various signals to and from one or more AVs 102A-102N in AV fleet 202 and/or user device 230 over network 220. Non-limiting examples of network 220 can include a public network (e.g., the Internet, an IaaS network, a PaaS network, a SaaS network, other CSP network etc.), a private network (e.g., a LAN, a private cloud, a VPN, etc.), a hybrid network (e.g., a multi-cloud or hybrid cloud network, etc.), or a combination of any of the above. In some cases, fleet management system 210 may be connected to one or more types of networks (e.g., network 220), which may be used differently when communicating with user device 230 or one or more AVs 102A-102N in AV fleet 202.

In some cases, each AV 102A-102N in AV fleet 202 can be equipped with various sensors (e.g., sensor systems 104-108 as illustrated in FIG. 1) that may capture sensor data, which may be transmitted to fleet management system 210 over network 220. For example, fleet management system 210 may receive sensor data from one or more AVs 102A-102N in AV fleet 202 that may be collected while the AV is navigating in a real-world driving environment. In some cases, the sensor data may be descriptive of an environment around the AV that can be used to determine or verify a location, orientation, position, and/or pose of the AV, road conditions, grades of the road, traffic conditions, temperature, weather conditions, etc.

In some examples, each AV 102A-102N in AV fleet 202 may transmit vehicle-specific information to fleet management system 210 over network 220. The vehicle-specific information can be associated with properties, characteristics, or attributes that may be specific to the respective AV. For example, the vehicle-specific information can include, without limitation, vehicle configurations, properties of the AV (e.g., dimensions, size, weight, shape, etc.), vehicle age, battery data (e.g., battery age, battery capacity, battery voltage, battery charge state, battery pack size, etc.), tire pressure, energy efficiency, fuel or battery efficiency, driving range, maximum and/or minimum speed, maximal torque, vehicle history (e.g., history of accidents or safety-critical events), engine temperature, ambient temperature, and so on.

In some cases, the vehicle-specific information may also include AV maintenance information (e.g., AV 102A-102N in AV fleet 202 may transmit maintenance information to fleet management system 210 over network 220). The maintenance information may be associated with the maintenance state and/or status of the respective AV. For example, the maintenance information can include, without limitation, battery charge level, data storage capacity level, remaining time until a required power cycle, remaining time until sensor calibration, remaining time until data offload, vehicle health-check cycle, sensor fault indications, and so on.

In some examples, fleet management system 210 can receive various signals from any other suitable databases/data centers (e.g., data center 150 as illustrated in FIG. 1 or a third-party data system). For example, data center 150 or a third-party data system may provide the above-described data associated with AVs 102A-102N in AV fleet 202 (e.g., sensor data or vehicle-specific information). Further, data center 150 or a third-party data system may provide any other available data (e.g., map data, traffic data, weather data, road condition data, etc.) to fleet management system 210 over network 220.

In some examples, fleet management system 210 may monitor the maintenance state and/or status of one or more AVs 102A-102N in AV fleet 202 and control any necessary and/or required maintenance of the AV(s) 102A-102N. For example, based on the current maintenance state (e.g., predicted battery charge level) and/or status of an AV (e.g., AV 102-102N), fleet management system 210 may schedule a trip to an AV maintenance facility for the AV and instruct the AV (or send instruction signals to the AV) to drive to the AV maintenance facility. In some aspects, the maintenance can include battery charging, sensor calibration, power cycling, offloading data, regular health check-ups, etc.

In some examples, fleet management system 210 may receive a ride request from user device 230 to transport one or more passengers from a pick-up location to a drop-off location (e.g., destination). In some cases, the ride request may include user's information such as a number of passengers, a preferred type of vehicle, a type of requested task (e.g., ridesharing and/or or ride-hailing services, food/grocery delivery, and/or parcel delivery services, etc.), driving preferences (e.g., comfort level, maximum speed, preferred speed, to avoid tolls, to avoid freeways/highways, etc.), accommodations, riding history, etc.

In some cases, fleet management system 210 is configured to match and dispatch an AV in response to a ride request received from user device 230. For example, upon receipt of a ride request from user device 230, fleet management system 210 may select an AV among one more AVs in AV fleet 202 based on the ride request, sensor data, vehicle-specific information, and/or any other available data as described above.

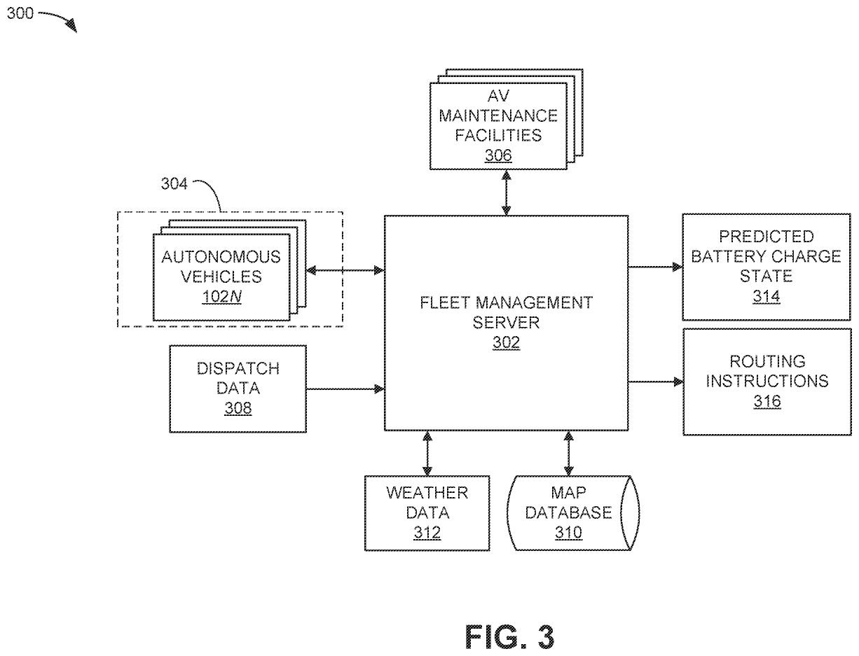

FIG. 3 illustrates an example of an AV fleet management system 300. In some aspects, fleet management system 300 can include a fleet management server 302 that can be configured to route a fleet of AVs (e.g., AV fleet 304) to one or more AV maintenance facilities 306 based on one or more different factors, as described further herein. In some cases, AV fleet 304 may correspond to AV fleet 202 as described in connection with FIG. 2 (e.g., AV fleet 304 may include AVs 102-102N).

In some examples, fleet management server 302 can communicate with one or more of the AVs in AV fleet 304. For instance, fleet management server 302 can receive data from AVs 102N. In some aspects, the data from AVs 102N can include location data (e.g., geographic coordinates, address, position, orientation, pose, etc.). In some cases, the data from the AVs 102N may include sensor data (e.g., LIDAR data, camera data, and/or any other data obtained using sensor systems 104-108). In some aspects, the data from the AVs 102N can include the output of one or more AV stacks (e.g., perception stack data corresponding to weather conditions, road conditions, traffic conditions, etc.).

In some instances, the data from the AVs 102N can include AV specific data that is associated with properties, characteristics, and/or attributes that may be specific to the respective AV. For example, vehicle-specific data can include AV battery data such as battery charge state, battery capacity, battery voltage, battery charge cycles, battery age, battery pack size, etc. In another example, the vehicle-specific characteristics received from the AVs 102N may include AV maintenance data such as data associated with sensor calibration, sensor replacement, low tire pressure, data offload, tire replacement, wheel alignment, exterior cleaning, interior cleaning, light replacement (e.g., headlight, taillight, brake light, cabin light), etc.

In some examples, fleet management server 302 may use the data received from AVs 102N to determine whether an AV should be routed to one of the AV maintenance facilities 306. For example, fleet management server 302 may use the AV location data and location data associated with one or more of the AV maintenance facilities 306 to determine the battery energy required for routing AVs 102N to one or more of the AV maintenance facilities 306.

In some cases, the battery energy required for routing AVs 102N to one or more of the AV maintenance facilities 306 may be based on the distance to the AV maintenance facility and/or the expected travel time to the AV maintenance facility. For example, the expected travel time to one or more of the AV maintenance facilities 306 may be based on traffic conditions, weather conditions (e.g., rain, snow, fog, temperature, etc.), road closures, construction zones, etc. In some cases, the traffic conditions may be determined based on data received from AV fleet 304 (e.g., fleet management server 302 can track movement of AV fleet 304 to determine traffic conditions). In some aspects, the weather conditions may be determined based on data received from one or more of AVs 102N (e.g., AVs may use sensor data to report ambient temperature, precipitation, visibility, etc.). In some examples, fleet management server 302 may receive weather data 312 from a third-party network (e.g., fleet management server 302 may use AV location data to query weather data 312 from a weather service provider).

In some examples, the battery energy required for routing an AV to an AV maintenance facility may be based on parameters associated with a selected route such as number of traffic lights, number of stop signs, speed limit(s), road grade, elevation changes, school zones, etc. In some examples, parameters associated with one or more routes to AV maintenance facilities 306 may be determined from map database 310. In some aspects, map database 310 may correspond to an HD geospatial database (e.g., HD geospatial database 126).

In some instances, the battery energy required for routing an AV to an AV maintenance facility can be based on vehicle-specific factors such as tire pressure, battery charge state, vehicle weight (e.g., depending on cargo and/or passengers), vehicle efficiency, road friction (e.g., based on road conditions, weather, tire tread, etc.), vehicle age (e.g., operation time, driving time, driving distance), and/or any other vehicle specific factor. In one illustrative example, the battery energy required for routing an AV to an AV maintenance facility may be based on the current battery charge state. That is, the battery discharge rate may differ at different charge levels (e.g., battery may discharge more slowly when near full capacity and may discharge at a faster rate when less than 50% capacity).

In some aspects, fleet management server 302 may calculate a predicted battery charge state 314 for one or more of AVs 102N that is based on the battery energy required for routing AVs 102N to one or more of the AV maintenance facilities 306. In some examples, fleet management server 302 may send routing instructions 316 to one or more of AVs 102N instructing the respective AV to travel to one of the AV maintenance facilities 306. For example, fleet management server 302 may route AVs 102N to one of the AV maintenance facilities 306 if fleet management server 302 determines that the predicted battery charge state 314 will be within an allowable range of a threshold battery charge state. In one illustrative example, fleet management server 302 may route an AV to one of the AV maintenance facilities 306 based on a determination that the predicted battery charge state 314 of the AV will be between 20% and 25% upon arriving at an AV maintenance facility (e.g., based on the current charge state and the battery energy required for traveling to the AV maintenance facility).

In some examples, fleet management server 302 may route AVs 102N to one of the AV maintenance facilities 306 based on one or more AV maintenance requirements. For example, fleet management server 302 may route AVs 102N to one of the AV maintenance facilities 306 for maintenance (e.g., sensor calibration, data offload, etc.). In some aspects, AV maintenance may also include battery charging. In some cases, the predicted battery charge state 314 of AVs 102N may vary depending on the maintenance requirement. For example, fleet management server 302 may route an AV to one of the AV maintenance facilities 306 irrespective of the predicted battery charge state 314 when the maintenance requirement is associated with a high priority. In another example, fleet management server 302 may attempt to optimize battery usage when the maintenance requirement is associated with a medium priority or a low priority. For instance, fleet management server 302 may route an AV to one of the AV maintenance facilities 306 for replacement of a cabin light when the predicted battery charge state 314 is below a threshold level (e.g., less than 30%).

In some cases, fleet management server 302 may route AVs 102N to one of the AV maintenance facilities 306 based on one or more operational metrics associated with the AV maintenance facilities 306. In some examples, the operational metrics may include the capacity of an AV maintenance facility, the occupancy of an AV maintenance facility, the capability of an AV maintenance facility, and/or the expected demand for an AV maintenance facility. In some instances, the capability of the AV maintenance facilities 306 may include maintenance capabilities (e.g., availability and/or capability of mechanics or technicians, availability of parts, maintenance equipment, capability of charging stations, etc.). In some cases, the capability of the AV maintenance facilities 306 can include the types of battery chargers at a respective maintenance facility. For example, some of the AV maintenance facilities 306 may be equipped with battery chargers that are capable of charging an AV battery faster than others based on capabilities such as charging current and/or charging voltage. In some cases, fleet management server 302 may communicate with AV maintenance facilities 306 to determine one or more of the operational metrics (e.g., AV maintenance facilities 306 may report current occupancy level).

In some configurations, fleet management server 302 may route AVs 102N to AV maintenance facilities 306 based on the operational metrics. For instance, fleet management server 302 may route an AV to an AV maintenance facility that results in a higher predicted battery charge state 314 based on a maintenance capability that is required for the AV (e.g., maintenance facility is equipped with rapid chargers). In another example, fleet management server 302 may route an AV to an AV maintenance facility based on the expected demand for an AV maintenance facility and/or the occupancy of an AV maintenance facility. That is, fleet management server 302 may intelligently select an AV maintenance facility to optimize occupancy and/or to retain availability based on an expected future demand for an AV maintenance facility. In one illustrative example, fleet management server 302 may intelligently identify one or more AV maintenance facilities 306 to send one or more of AVs 102N based on availability of battery chargers. That is, fleet management server 302 may consider the current charging plan for AV fleet 304, the expected arrival time of one or more of AVs 102N at a facility, and/or the predicted battery charge state 314). In some cases, the expected future demand for an AV maintenance facility may be based on historical use of the AV maintenance facility. In some examples, the expected future demand for an AV maintenance facility may be based on planned routes (e.g., ridesharing, deliveries, etc.) of the AV fleet 304.

In some cases, fleet management server 302 may route AVs 102N to AV maintenance facilities 306 based on dispatch data 308. In some aspects, dispatch data 308 may include requests for ride-hailing services, ridesharing services, food/grocery delivery services, parcel delivery services, etc. that are associated with one or more waypoints. For example, a ride-hailing request can be associated with a passenger pick-up location and a passenger drop-off location. In some cases, the dispatch data 308 can include requests for services that are associated with a particular or a preferred type of vehicle. For instance, a ridesharing service request for 6 passengers may correspond to a larger vehicle than a ridesharing service request for 1 passenger. In another example, a parcel delivery request for a large package may correspond to a vehicle with a larger cargo area.

In some aspects, the dispatch data 308 may include scheduled services and/or on-demand services. For example, dispatch data 308 may include a request for immediate food/grocery delivery service. In another example, dispatch data 308 may include a request for passenger pick-up/drop-off at a later day/time.

In some cases, fleet management server 302 may calculate a predicted battery charge state 314 for one or more of AVs 102N that is based on the battery energy required for routing AVs 102N to one or more waypoints associated with dispatch data 308. For example, fleet management server 302 may use the AV location data and location data associated with one or more of the waypoints corresponding to dispatch data 308 to determine the battery energy required for routing AVs 102N to the waypoints. As noted above with respect to the battery energy required for routing AVs 102N to maintenance facilities 306, the battery energy required for routing AVs 102N to one or more waypoints corresponding to dispatch data may further be based on expected travel time (e.g., traffic conditions, weather conditions, road closures, etc.), route parameters (e.g., traffic lights, speed limit, stop signs, road grade, etc.), vehicle-specific factors (e.g., battery charge state, vehicle weight, friction, etc.), etc.

In some aspects, fleet management server 302 may calculate a predicted battery charge state 314 for one or more of AVs 102N that is based on the battery energy required for routing AVs 102N to one or more waypoints (e.g., based on dispatch data 308) and the battery energy required for routing AVs 102N to AV maintenance facilities 306. For example, based on the overall battery energy required, fleet management server 302 may direct an AV (e.g., via routing instructions 316) to serve a ride-hailing request before proceeding to one of the AV maintenance facilities 306. For instance, fleet management server 302 may determine that a final waypoint associated with a service request (e.g., based on dispatch data) is in the proximity of an AV maintenance facility that can perform maintenance on the AV after the AV completes the service request.

In some cases, fleet management server 302 can use historical dispatch data 308 to anticipate a demand for AV fleet 304. For example, fleet management server 302 can use historical dispatch data 308 to anticipate a greater need for AVs in the downtown area of San Francisco at or around 5:00 PM. In some aspects, fleet management server 302 may dispatch one or more AVs 102N to AV maintenance facilities 306 prior to the anticipated demand so that AVs 102N are available to service future requests. In one illustrative example, fleet management server 302 may direct one or more AVs 102N to AV maintenance facilities 306 for battery charging although the predicted battery charge state 314 upon arrival at the AV maintenance facility is relatively high (e.g., AV arrives at AV maintenance facility with battery charge state of 70%) so that AVs 102N do not require charging at a later time when demand for AVs 102N is increased.

In some examples, dispatch data 308 may include data associated with one or more events (e.g., event data) that may impact the demand for AV fleet 304. For instance, event data may include data corresponding to a sporting event, a concert, a conference, flight arrival, flight departure, cruise arrival, cruise departure, an exhibit, and/or any other type of event that may attract a greater amount of people to travel to or from a particular geographic area. As noted above with respect to historical dispatch data, the fleet management server 302 may use event data (e.g., included from dispatch data 308 or obtained from a third-party source) to dispatch AVs 102N to AV maintenance facilities 306 such that AV fleet 304 is able to accommodate increased demand due to the event. In some instances, fleet management server 302 may consider aspects of event data such as the geographic location of the event, the anticipated number of people associated with the event, the start time of the event, the end time of the event, etc.

In some aspects, fleet management server 302 may include one or more machine learning modules or implement machine learning algorithms to generate predicted battery charge state 314 and/or routing instructions 316. For example, a machine learning model can be trained to determine the battery energy required to route AVs 102N to AV maintenance facilities 306 and/or to one or more waypoints associated with dispatch data 308. In another example, a machine learning model can be trained to allocate available resources that are associated with the AV maintenance facilities 306 such that usage of AV fleet 304 is optimized based on dispatch data 308.

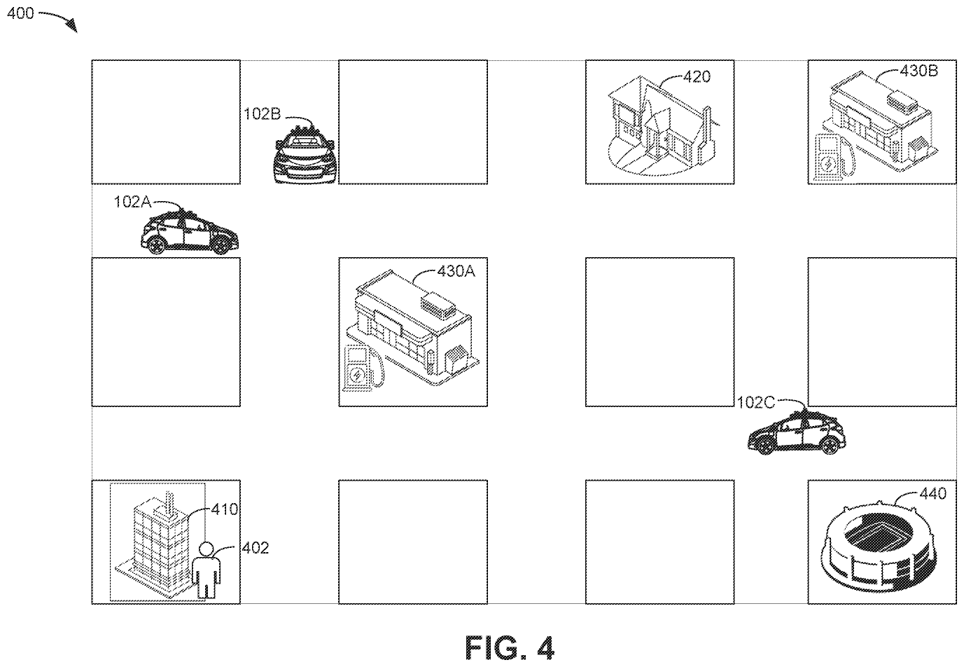

FIG. 4 illustrates an example scene 400 for dispatching AVs to AV maintenance facilities. As illustrated, example scene 400 includes multiple AVs, such as AV 102A, AV 102B, and AV 102C. As noted above, AVs 102A-102C can be part of a fleet (e.g., AV fleet 202), which may be managed and controlled by a fleet management system (e.g., fleet management system 210 or fleet management server 302). In some aspects, example scene 400 may include AV maintenance facility 430A and AV maintenance facility 430B. In some cases, example scene 400 may include a user 402 (or a ride requestor) that has requested a ride between pick-up location 410 and drop-off location 420 (e.g., destination). In some aspects, example scene 400 may also include an event location such as stadium 440.

In some cases, the fleet management server can receive AV data from AVs 102A-102C that can include AV location data and AV battery data. In some examples, the fleet management server can determine the battery energy required to route one or more of AVs 102A-102C to AV maintenance facility 430A and/or AV maintenance facility 430B. As noted above, the battery energy required to navigate to a maintenance facility and/or any other waypoint can be based on travel distance, predicted travel time (e.g., based on traffic conditions, weather conditions, road closures, etc.), route parameters (e.g., traffic lights, speed limit, stop signs, road grade, etc.), vehicle-specific factors (e.g., battery charge state, vehicle weight, friction, etc.), etc.

In some aspects, the fleet management server can determine a predicted battery charge state for each of the AVs 102A-102C upon arriving at AV maintenance facility 430A and/or AV maintenance facility 430B. In some aspects, the fleet management server may route (e.g., send routing instructions) one or more of the AVs 102A-102C to AV maintenance facility 430A or AV maintenance facility 430B based on the predicted battery charge state (e.g., predicted battery charge state less than or equal to a threshold battery charge state). For example, AV 102A may be routed to AV maintenance facility 430B, which is further away than AV maintenance facility 430A, based on the predicted battery charge state.

In some aspects, the fleet management server may route AVs 102A-102C to AV maintenance facility 430A or AV maintenance facility 430B based on a maintenance requirement (e.g., sensor calibration, brake maintenance, headlight replacement, etc.). In some cases, the AV maintenance facility may be selected based on one or more operational metrics (e.g., capacity metric, occupancy metric, capability metric, demand metric, etc.). For example, AV 102C may be routed to AV maintenance facility 430A instead of AV maintenance facility 430B because AV maintenance facility 430B may not be equipped to perform required maintenance.

In some examples, the fleet management server may receive dispatch data that can include a ride request from user 402 (e.g., transportation from pick-up location 410 to drop-off location 420). In some instances, the fleet management server may determine the battery energy required for one or more of the AVs 102A-102C to navigate to the waypoints associated with the ride request (e.g., battery energy required to navigate to pick-up location 410 then to drop-off location 420). In some aspects, the fleet management server may also determine the battery energy required for one or more of the AVs 102A-102C to navigate from the drop-off location 420 to AV maintenance facility 430A and/or AV maintenance facility 430B. In some examples, the fleet management server may select one of the AVs 102A-102C to service the ride request from user 402 based on the predicted battery charge state of the selected AV upon arrival at one of the AV maintenance facilities (e.g., AV maintenance facility 430A or AV maintenance facility 430B) after completing the ride request.

In some aspects, the fleet management server may select one of the AVs 102A-102C to service the ride request from user 402 based on a maintenance requirement. For example, the fleet management server may select one of the AVs 102A-102C based on the time remaining until the AV has to perform a data offload and/or the capability of an AV maintenance facility to accommodate the data offload.

In some configurations, the fleet management server may route one or more of AVs 102A-102C to AV maintenance facility 430A or AV maintenance facility 430B based on dispatch data. For example, historical dispatch data may indicate that the geographic area around pick-up location 410 (e.g., an office building) is associated with an increased demand for passenger pick-up at 5:00 PM. In some aspects, the fleet management server may route AVs 102A-102C to AV maintenance facility 430A such that a charge cycle is completed prior to 5:00 PM and the respective AVs are in vicinity of pick-up location 410 for servicing the increased demand.

In some cases, the dispatch data may include data corresponding to an event. For example, dispatch data may indicate that a sporting event is taking place at stadium 440. In some examples, the fleet management server may instruct one or more of AVs 102A-102C to complete charging and/or maintenance tasks at AV maintenance facility 430A or AV maintenance facility 430B prior to the time of the expected increased demand in the vicinity of stadium 440. In one illustrative example, one or more of AVs 102A-102C may be directed to an AV maintenance facility (e.g., AV maintenance facility 430A or AV maintenance facility 430B) to complete a charge cycle irrespective of the predicted battery charge state such that AVs 102A-102C are available to travel to stadium 440 for servicing the increase in demand.

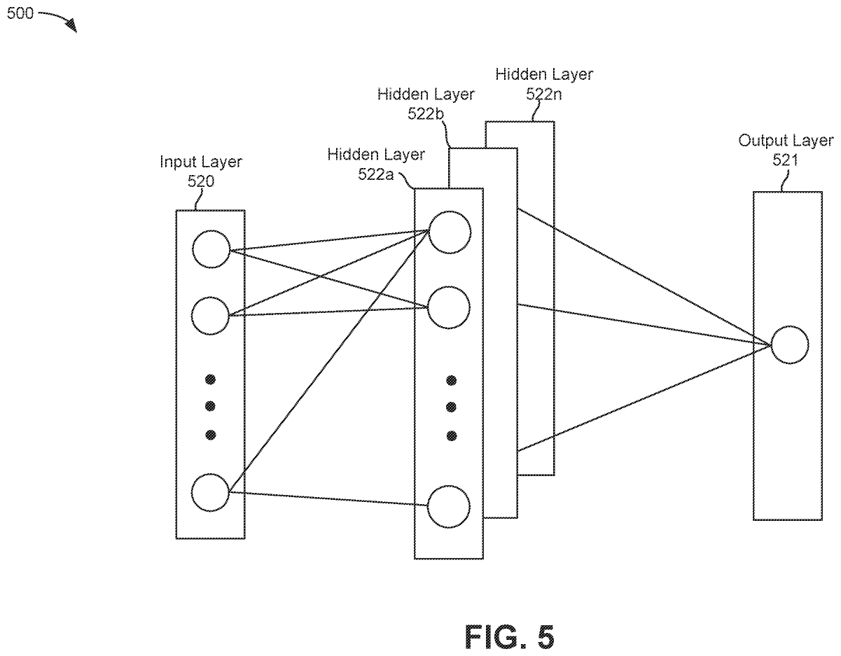

In FIG. 5, the disclosure now turns to a further discussion of models that can be used through the environments and techniques described herein. FIG. 5 is an example of a deep learning neural network 500 that can be used to implement all, or a portion of the systems and techniques described herein as discussed above (e.g., neural network 500 can be used to implement aspects of battery charge state predictions and/or to determine AV routing instructions). For example, an input layer 520 can be configured to receive AV location data, AV battery data, AV maintenance data, map data (e.g., route parameters), traffic data, weather data, AV maintenance facility location data, AV maintenance facility operational metrics, and/or dispatch data. Neural network 500 includes multiple hidden layers 522a, 522b, through 522n. The hidden layers 522a, 522b, through 522n include “n” number of hidden layers, where “n” is an integer greater than or equal to one. The number of hidden layers can be made to include as many layers as needed for the given application. Neural network 500 further includes an output layer 521 that provides an output resulting from the processing performed by the hidden layers 522a, 522b, through 522n. For instance, the output may include a predicted charge state for an AV upon navigating to an AV maintenance facility and/or one or more waypoints associated with dispatch data. In another example, the output layer may include routing instructions for directing an AV fleet to attend to one or more service requests (e.g., based on dispatch data) and navigate to AV maintenance facilities for battery charging and AV maintenance.

Neural network 500 is a multi-layer neural network of interconnected nodes. Each node can represent a piece of information. Information associated with the nodes is shared among the different layers and each layer retains information as information is processed. In some cases, the neural network 500 can include a feed-forward network, in which case there are no feedback connections where outputs of the network are fed back into itself. In some cases, the neural network 500 can include a recurrent neural network, which can have loops that allow information to be carried across nodes while reading in input.

Information can be exchanged between nodes through node-to-node interconnections between the various layers. Nodes of the input layer 520 can activate a set of nodes in the first hidden layer 522a. For example, as shown, each of the input nodes of the input layer 520 is connected to each of the nodes of the first hidden layer 522a. The nodes of the first hidden layer 522a can transform the information of each input node by applying activation functions to the input node information. The information derived from the transformation can then be passed to and can activate the nodes of the next hidden layer 522b, which can perform their own designated functions. Example functions include convolutional, up-sampling, data transformation, and/or any other suitable functions. The output of the hidden layer 522b can then activate nodes of the next hidden layer, and so on. The output of the last hidden layer 522n can activate one or more nodes of the output layer 521, at which an output is provided. In some cases, while nodes in the neural network 500 are shown as having multiple output lines, a node can have a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 520 using the different hidden layers 522a, 522b, through 522n in order to provide the output through the output layer 521.

In some cases, the neural network 500 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 500 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½(target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 500 can perform a backward pass by determining which inputs (weights) most contributed to the loss of the network and can adjust the weights so that the loss decreases and is eventually minimized.

The neural network 500 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 500 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

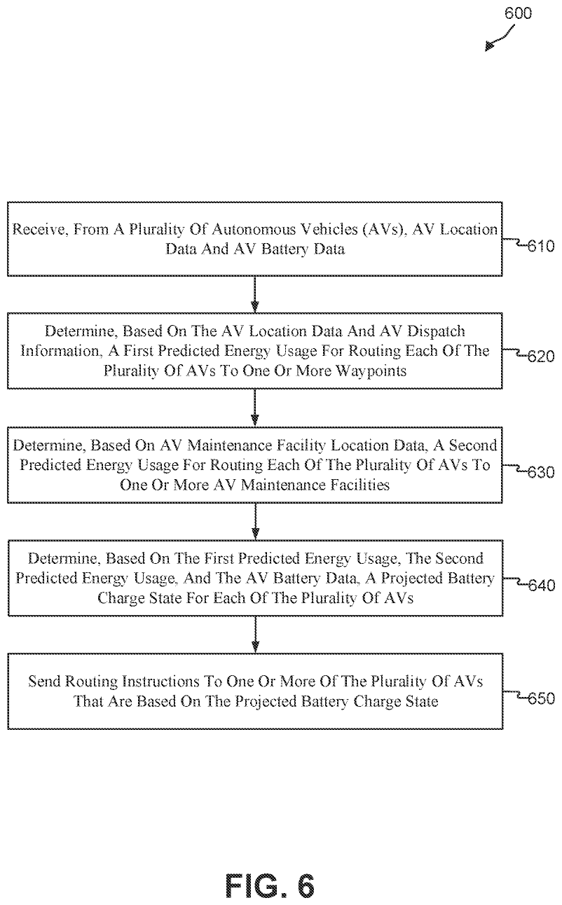

FIG. 6 is a flowchart illustrating an example process 600 for dispatching one or more autonomous vehicles to an AV maintenance facility. Although the example process 600 depicts a particular sequence of operations, the sequence may be altered without departing from the scope of the present disclosure. For example, some of the operations depicted may be performed in parallel or in a different sequence that does not materially affect the function of process 600. In other examples, different components of an example device or system that implements process 600 may perform functions at substantially the same time or in a specific sequence.

At block 610, the process 600 includes receiving, from a plurality of autonomous vehicles (AVs), AV location data and AV battery data. For example, fleet management server 302 can receive AV location data and AV battery data from AVs 102N.

At block 620, the process 600 includes determining, based on the AV location data and AV dispatch information, a first predicted energy usage for routing each of the plurality of AVs to one or more waypoints. For instance, fleet management server 302 can determine, based on AV location data and dispatch data 308, energy usage for routing AVs 102A-102C to pick-up location 410 and drop-off location 420 (e.g., obtained from dispatch data 308). In some cases, the AV dispatch information can include at least one of a passenger pickup from the one or more waypoints, a passenger drop-off from the one or more waypoints, and a delivery to the one or more waypoints.

At block 630, the process 600 includes determining, based on AV maintenance facility location data, a second predicted energy usage for routing each of the plurality of AVs to one or more AV maintenance facilities. For example, fleet management server 302 can determine, based on AV maintenance facility location data, energy usage for routing AVs 102A-102C to AV maintenance facility 430A and/or AV maintenance facility 430B. In some cases, the predicted energy usage can be based on routing the AV to a respective AV maintenance facility from the current location of the AV. In some instances, the predicted energy usage can be based on routing the AV to a respective AV maintenance facility from a waypoint such as drop-off location 420.

At block 640, the process 600 includes determining, based on the first predicted energy usage, the second predicted energy usage, and the AV battery data, a projected battery charge state for each of the plurality of AVs. For example, fleet management server 302 can determine predicted battery charge state 314 for AVs 102A-102C. In some aspects, the first predicted energy usage and the second predicted energy usage can be further based on at least one of a travel time, a road condition, a weather condition, a time of day, a traffic condition, and a vehicle attribute (e.g., a vehicle-specific factor).

At block 650, the process 600 includes sending routing instructions to one or more of the plurality of AVs that are based on the projected battery charge state. For instance, fleet management server 302 can send routing instructions 316 to one or more of AVs 102A-102C. In some cases, the routing instructions 316 may instruct the respective AV to navigate directly to one of the AV maintenance facilities 306. In some aspects, the routing instructions 316 may instruct the respective AV to navigate to one or more waypoints (e.g., associated with dispatch data 308) prior to navigating to one of the AV maintenance facilities 306. In some examples, the first predicted energy usage is less than the second predicted energy usage, and the routing instructions include instructions to the one or more waypoints.

In some examples, the process 600 can include predicting a demand for a portion of the plurality of AVs in a geographic area, wherein the routing instructions are further based on the demand. For instance, fleet management server 302 can predict a demand for a portion of AV fleet 304 in a geographic area. In some cases, the demand can be based on historical dispatch information associated with the geographic area. In some instances, the demand can be based on event data associated with the geographic area. For example, fleet management server 302 can determine the demand based on event data corresponding to an event at stadium 440.

In some instances, the process 600 can include determining that the projected battery charge state is less than a threshold battery charge state. For example, fleet management server 302 can determine that predicted battery charge state 314 is less than a threshold battery charge state. In some cases, the threshold battery charge state can be used to determine whether an AV requires charging. That is, if the predicted battery charge state 314 (e.g., predicted battery charge state upon arrival at an AV maintenance facility) is less than the threshold, the routing instructions 316 may direct the AV to an AV maintenance facility for charging.

In some examples, the process 600 may include determining a service requirement for each of the plurality of AVs, wherein the routing instructions are further based on the service requirement. For instance, fleet management server 302 can determine a service requirement (e.g., sensor calibration, wheel alignment, etc.) for one or more of AVs 102N based on data received from an AV and/or based on a required maintenance schedule. In some aspects, the routing instructions 316 can be based on the service requirement. That is, AVs 102N may be routed to AV maintenance facilities 306 based on the service requirement.

In some aspects, the process 600 may include determining an operational metric for the one or more AV maintenance facilities, wherein the routing instructions are further based on the operational metric. For example, fleet management server 302 may determine operational metrics corresponding to AV maintenance facility 430A and/or AV maintenance facility 430B. In some cases, the operational metrics can include the capacity of an AV maintenance facility, the occupancy of an AV maintenance facility, the capability of an AV maintenance facility, and/or the expected demand for an AV maintenance facility.

FIG. 7 illustrates an example processor-based system with which some aspects of the subject technology can be implemented. For example, processor-based system 700 can be any computing device making up, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some examples, computing system 700 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 700 includes at least one processing unit (Central Processing Unit (CPU) or processor) 710 and connection 705 that couples various system components including system memory 715, such as Read-Only Memory (ROM) 720 and Random-Access Memory (RAM) 725 to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communication interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 730 can include software services, servers, services, etc., that when the code that defines such software is executed by the processor 710, it causes the system 700 to perform a function. In some examples, a hardware service that performs a particular function can include the software component stored in a computer-readable medium in connection with the necessary hardware components, such as processor 710, connection 705, output device 735, etc., to carry out the function.

Examples within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the examples and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

### Illustrative Examples of the Disclosure Include:

Aspect 1. A method comprising: receiving, from a plurality of autonomous vehicles (AVs), AV location data and AV battery data; determining, based on the AV location data and AV dispatch information, a first predicted energy usage for routing each of the plurality of AVs to one or more waypoints; determining, based on AV maintenance facility location data, a second predicted energy usage for routing each of the plurality of AVs to one or more AV maintenance facilities; determining, based on the first predicted energy usage, the second predicted energy usage, and the AV battery data, a projected battery charge state for each of the plurality of AVs; and sending routing instructions to one or more of the plurality of AVs that are based on the projected battery charge state.

Aspect 2. The method of Aspect 1, further comprising: predicting a demand for a portion of the plurality of AVs in a geographic area, wherein the routing instructions are further based on the demand.

Aspect 3. The method of Aspect 2, wherein the demand is based on historical dispatch information associated with the geographic area.

Aspect 4. The method of any of Aspects 2 to 3, wherein the demand is based on event data associated with the geographic area.

Aspect 5. The method of any of Aspects 1 to 4, further comprising: determining that the projected battery charge state is less than a threshold battery charge state.

Aspect 6. The method of any of Aspects 1 to 5, wherein the first predicted energy usage is less than the second predicted energy usage, and wherein the routing instructions include instructions to the one or more waypoints.

Aspect 7. The method of any of Aspects 1 to 6, wherein the AV dispatch information includes at least one of a passenger pickup from the one or more waypoints, a passenger drop-off from the one or more waypoints, and a delivery to the one or more waypoints.

Aspect 8. The method of any of Aspects 1 to 7, further comprising: determining a service requirement for each of the plurality of AVs, wherein the routing instructions are further based on the service requirement.

Aspect 9. The method of any of Aspects 1 to 8, further comprising: determining an operational metric for the one or more AV maintenance facilities, wherein the routing instructions are further based on the operational metric, and wherein the operational metric includes at least one of a capacity metric, an occupancy metric, and a capability metric.

Aspect 10. The method of any of Aspects 1 to 9, wherein the first predicted energy usage and the second predicted energy usage are further based on at least one of a travel time, a road condition, a weather condition, a time of day, a traffic condition, and a vehicle attribute.

Aspect 11. An apparatus comprising: at least one memory; and at least one processor coupled to the at least one memory, wherein the at least one processor is configured to perform operations in accordance with any one of Aspects 1 to 10.

Aspect 11. An apparatus comprising means for performing operations in accordance with any one of Aspects 1 to 10.

Aspect 12. A non-transitory computer-readable medium comprising instructions that, when executed by an apparatus, cause the apparatus to perform operations in accordance with any one of Aspects 1 to 10.

What is claimed is:

1. A fleet management system comprising:
a memory; and
one or more processors coupled to the memory, the one or more processors being configured to:
receive, from a plurality of autonomous vehicles (AVs), AV location data and AV battery data;
determine, based on the AV location data and AV dispatch information, a first predicted energy usage for routing each of the plurality of AVs to one or more waypoints;
determine, based on AV maintenance facility location data, a second predicted energy usage for routing each of the plurality of AVs to one or more AV maintenance facilities;
determine, based on the first predicted energy usage, the second predicted energy usage, and the AV battery data, a projected battery charge state for each of the plurality of AVs; and
send routing instructions to one or more of the plurality of AVs that are based on the projected battery charge state.

2. The fleet management system of claim 1, wherein the one or more processors are further configured to:
predict a demand for a portion of the plurality of AVs in a geographic area, wherein the routing instructions are further based on the demand.

3. The fleet management system of claim 2, wherein the demand is based on historical dispatch information associated with the geographic area.

4. The fleet management system of claim 2, wherein the demand is based on event data associated with the geographic area.

5. The fleet management system of claim 1, wherein the one or more processors are further configured to:
determine that the projected battery charge state is less than a threshold battery charge state.

6. The fleet management system of claim 1, wherein the first predicted energy usage is less than the second predicted energy usage, and wherein the routing instructions include instructions to the one or more waypoints.

7. The fleet management system of claim 1, wherein the AV dispatch information includes at least one of a passenger pickup from the one or more waypoints, a passenger drop-off from the one or more waypoints, and a delivery to the one or more waypoints.

8. The fleet management system of claim 1, wherein the one or more processors are further configured to:
determine a service requirement for each of the plurality of AVs, wherein the routing instructions are further based on the service requirement.

9. The fleet management system of claim 1, wherein the one or more processors are further configured to:
determine an operational metric for the one or more AV maintenance facilities, wherein the routing instructions are further based on the operational metric, and wherein the operational metric includes at least one of a capacity metric, an occupancy metric, and a capability metric.

10. The fleet management system of claim 1, wherein the first predicted energy usage and the second predicted energy usage are further based on at least one of a travel time, a road condition, a weather condition, a time of day, a traffic condition, and a vehicle attribute.

11. A method comprising:
receiving, from a plurality of autonomous vehicles (AVs), AV location data and AV battery data;
determining, based on the AV location data and AV dispatch information, a first predicted energy usage for routing each of the plurality of AVs to one or more waypoints;
determining, based on AV maintenance facility location data, a second predicted energy usage for routing each of the plurality of AVs to one or more AV maintenance facilities;
determining, based on the first predicted energy usage, the second predicted energy usage, and the AV battery data, a projected battery charge state for each of the plurality of AVs; and
sending routing instructions to one or more of the plurality of AVs that are based on the projected battery charge state.

12. The method of claim 11, further comprising:
predicting a demand for a portion of the plurality of AVs in a geographic area, wherein the routing instructions are further based on the demand.

13. The method of claim 12, wherein the demand is based on historical dispatch information associated with the geographic area.

14. The method of claim 12, wherein the demand is based on event data associated with the geographic area.

15. The method of claim 11, further comprising:
determining that the projected battery charge state is less than a threshold battery charge state.

16. The method of claim 11, wherein the first predicted energy usage is less than the second predicted energy usage, and wherein the routing instructions include instructions to the one or more waypoints.

17. The method of claim 11, further comprising:
determining a service requirement for each of the plurality of AVs, wherein the routing instructions are further based on the service requirement.

18. The method of claim 11, further comprising:
determining an operational metric for the one or more AV maintenance facilities, wherein the routing instructions are further based on the operational metric, and wherein the operational metric includes at least one of a capacity metric, an occupancy metric, and a capability metric.

19. A non-transitory computer-readable media comprising instructions stored thereon which, when executed are configured to cause a computer or processor to:
receive, from a plurality of autonomous vehicles (AVs), AV location data and AV battery data;
determine, based on the AV location data and AV dispatch information, a first predicted energy usage for routing each of the plurality of AVs to one or more waypoints;
determine, based on AV maintenance facility location data, a second predicted energy usage for routing each of the plurality of AVs to one or more AV maintenance facilities;
determine, based on the first predicted energy usage, the second predicted energy usage, and the AV battery data, a projected battery charge state for each of the plurality of AVs; and
send routing instructions to one or more of the plurality of AVs that are based on the projected battery charge state.

20. The non-transitory computer-readable media of claim 19, comprising further instructions configured to cause the computer or processor to:
predict a demand for a portion of the plurality of AVs in a geographic area, wherein the routing instructions are further based on the demand.
